(19) United States
(12) Patent Application Publication
(10) Pub. No.: US 2007/0133446 A1
(43) Pub. Date: Jun. 14, 2007

(54) Transmitting apparatus of wireless communication system and method thereof

(75) Inventors: Chan-Ho Yoon, Seoul (KR); Hee-Jung Yu, Daejeon-city (KR); Eun-Young Choi, Daejeon-city (KR); Jung-Bo Son, Masan-city (KR); Il-Gu Lee, Seoul (KR); Deuk-Su Lyu, Daejeon-city (KR); Tae-hyun Jeon, Sungnam-city (KR); Seung-Wook Min, Seoul (KR); Kwhang-Hyun Ryu, Daejeon-city (KR); Kyoung-Ju Noh, Daejeon-city (KR); Yun-Joo Kim, Daejeon-city (KR); Kyoung-Hee Song, Jeonju-city (KR); Sok-Kyu Lee, Daejeon-city (KR); Seung-chan Bang, Daejeon-city (KR); Seung-Ku Hwang, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/636,448

(22) Filed: Dec. 11, 2006

(30) Foreign Application Priority Data
Dec. 10, 2005 (KR) 10-2005-0121345
May 9, 2006 (KR) 10-2006-0041349

(51) Int. Cl. H04B 7/00

(52) U.S. Cl. 370/310

(57) ABSTRACT

The present invention relates to a transmitting apparatus of a wireless communication system, and a method thereof. The transmitting apparatus monitors receiving of response data for data that has been transmitted to a receiving end, and sets a first parameter for counting successful receipts according to receiving on the response data. The transmitting apparatus demodulates the response data and extracts the number of demodulated data that satisfies a first set value. Subsequently, it is determined whether the first parameter satisfies a second set value and the number of demodulated data satisfies a predetermined ratio of a referential amount of packets. According to the present invention, an efficient transmission mode for a channel state can be provided with reference to an extracted number of soft-decision data from response data received at a receiving end. In addition, a transmission mode can be determined by using only response data according to the present invention.

### CROSS-REFERENCE TO RELATED APPLICATION

This application claims priority to and the benefit of Korean Patent Application Nos. 10-2005-0121345 and 10-2006-0041349 filed in the Korean Intellectual Property Office on Dec. 10, 2005, and May 9, 2006, the entire contents of which are incorporated herein by reference.

### BACKGROUND OF THE INVENTION

(a) Field of the Invention

The present invention relates a transmitting apparatus of a wireless communication system and a method thereof. More particularly, the present invention relates to a transmitting apparatus of a distributed coordinated function (DCF)-based wireless communication system, the transmitting apparatus having a transmission rate that varies depending on a channel condition, and a method thereof.

(b) Description of the Related Art

When transmitting/receiving data packets in a wireless communication system, a data packet transmission error rate varies depending on a transmission rate. Therefore, various algorithms have been studied for controlling various data rates to maintain the transmission error rate at a constant level, and an auto rate fallback (ARF) algorithm is the most well-known algorithm for maintaining a constant data packet transmission error.

According to the ARF algorithm, when ACK signals for two consecutive data packets are not received by a transmit side, the transmit side reduces the transmission rate to the next lower rate, whereas the transmit side increases the transmission rate to the next higher rate when ACK signals for 10 consecutive data packets are successfully received by the transmit side.

Such an ARF algorithm does not require modification of the standard medium access control (MAC) function in the 802.11 system and thus it can be directly applied to a commercial product, but the adaptability is significantly decreased due to rapid channel variation.

In addition, according to another conventional transmission rate control algorithm, a transmission rate can be determined on the basis of the size of a signal of a received packet and the number of retransmissions.

According to this algorithm, a mean signal intensity of received response packets is estimated and a transmission rate is selected on the basis of a predetermined reference table. Thus, the signal intensity of previously received response packets is estimated and the next data transmission is performed on the basis of the estimated signal intensity, and the transmission rate is modified depending on success or failure of data transmission on the basis of the reference table.

However, when the transmission rate is determined on the basis of the signal size of the received packet and the number of retransmissions, the probability of occurrence of collision between packets may increase when multiple wireless stations exist, thereby increasing the probability of error occurrence during transmission rate control.

The above information disclosed in this Background section is only for enhancement of understanding of the background of the invention and therefore it may contain information that does not form the prior art that is already known in this country to a person. of ordinary skill in the art.

### SUMMARY OF THE INVENTION

In order to solve the above-stated problems, the present invention has been made in an effort to provide a transmitting apparatus of a distributed coordinate function (DCF)-based wireless communication system, the transmitting apparatus having a transmission rate according to a channel state, and a method thereof.

A transmitting apparatus of a wireless communication system according to an exemplary embodiment of the present invention includes a transmitting/receiving module, a modulator, and a demodulator. The transmitting/receiving apparatus exchanges data with a receiving end. The modulator modulates a received data bit according to a transmission mode, and transmits the modulated data to the transmitting/receiving module. The demodulator includes a first parameter, a second parameter, and a third parameter, changes the first, second, and third parameters according to receiving of response data corresponding to the modulated data, and demodulates the response data and extracts the number of demodulated data that satisfies a specific value. The first parameter counts successful receiving, the second parameter counts failed receiving, and the third parameter counts retransmission.

The demodulator increases the first parameter when receiving the response data from the transmitting/receiving module, extracts the number of data that satisfies the specific value by demodulating the received response data, and increases a transmission rate by changing the transmission mode based on the extracted number of data and the increased first parameter.

In addition, the demodulator increases the second and third parameters according to a failure of receiving of the response data, decreases the transmission rate by changing the transmission mode when the increased second parameter satisfies a first set value, and retransmits data when the increased third parameter satisfies a second set value.

A transmission method according to another embodiment of the present invention is provided to a wireless communication system that transmits specific data to a receiving end. The method includes a) monitoring receiving of response data for data that has been transmitted to the receiving end; b) setting a first parameter for counting successful receiving according to the receiving of the response data; c) demodulating the response data, and extracting the number of data that satisfies a first value according to the demodulation; d) determining whether the first parameter satisfies a second set value and determining whether the number of data satisfies a predetermined ratio of a referential amount of packets; and e) changing a transmission mode when the second set value and the predetermined ratio are satisfied according to a result of the determination.

### BRIEF DESCRIPTION OF THE DRAWINGS

FIG. 1 is a block diagram of a transmitting apparatus of a wireless communication system according to an exemplary embodiment of the present invention.

FIG. 2 is a flowchart of a data transmission process of the transmitting apparatus of the wireless communication system according to an exemplary embodiment of the present invention.

### DETAILED DESCRIPTION OF THE EMBODIMENTS

An exemplary embodiment of the present invention will hereinafter be described in detail with reference to the accompanying drawings. In the following detailed description, only certain exemplary embodiments of the present invention have been shown and described, simply by way of illustration.

As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” or variations such as “comprises” or “comprising” will be understood to imply the inclusion of stated elements but not the exclusion of any other elements.

Further, throughout this specification and the claims which follow, a module means a unit that performs a specific function or operation, and can be realized by hardware or software, or a combination of both.

A wireless communication system according to an exemplary embodiment of the present invention and a method thereof will now be described in more detail with reference to the accompanying drawings.

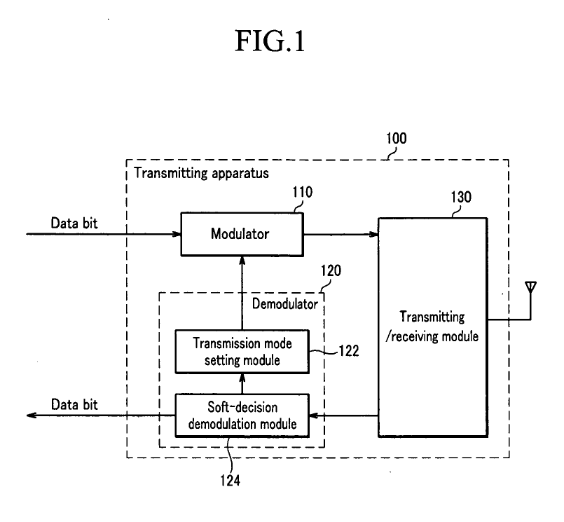

FIG. 1 is a block diagram of a transmitting apparatus of a wireless communication according to an exemplary embodiment of the present invention.

As shown in FIG. 1, the transmitting apparatus according to the exemplary embodiment of the present invention includes a modulator 110, a demodulator 120, and a transmitting/receiving module 130, and it determines a transmission rate for data to be transmitted by estimating a channel condition based on response data from a receiving end.

The modulator 110 includes a convolutional encoding module, and it receives a data bit from a previous end (not shown), modulates the data on the basis of a modulation algorithm and a convolutional code parameter, and transmits the modulated data to the transmitting/receiving module 130, wherein the modulation algorithm and the convolutional code parameter are set by a transmission mode setting module 122.

The demodulator 120 includes a soft decision demodulation module 124 and the transmission mode setting module 122, and decodes the data transmitted from the transmitting/receiving module 130 and generates soft decision data. Also, the demodulator 120 extracts the number of soft decision data whose absolute value satisfies a predetermined maximum absolute value and stores the extracted number of soft decision data.

In addition, the demodulator 120 controls a transmission rate by changing a modulation algorithm of the modulator 110 on the basis of the number of soft decision data stored therein. In this case, a channel is in a good state when a signal-to-noise ratio (SNR) is high and a transmission function value of a channel is large, and therefore an absolute value of a soft-decision decoded signal is set to be relatively high.

The soft-decision demodulation module 124 demodulates the data transmitted from the transmitting/receiving module 130 and transmits the demodulated data to the next end, extracts the number of soft-decision demodulated data whose absolute value corresponds to a predetermined maximum absolute value on the basis of the soft-decision demodulated data, and transmits the extraction result to the transmission mode setting module 122. The soft-decision demodulation module 124 stores the number of soft-decision data having the maximum absolute value.

In addition, the soft-decision demodulation module 124 includes an internal timer, and transmits information based on whether the transmission mode setting module 122 receives response data (ACK) transmitted from the transmitting/receiving module 130.

The transmission mode setting module 122 receives the number of soft-decision data transmitted from the soft-decision demodulation module 124 and determines a channel condition by comparing the number of soft-decision data and the number of soft-output bits in accordance with predetermined modulation/demodulation schemes in Table 1. In addition, the transmission mode setting module 122 determines a modulation scheme and a convolutional code parameter to be used on the basis of the determined information and controls the modulator 110.

TABLE 1

| Transmission | Soft-output bits | | |
|---|---|---|---|
| rate | (referential | Number | |
| (modulation | amount of | of OFDM | Mod. |
| method) | data packet) | symbols | Symbols |
| BPSK 1/2 | (18*8)*(2/1) = 288 | 288/48 = | 6*48 = 288 |
| | bits | 6 OFDM | |
| | | symbols | |
| BPSK 3/4 | (18*8)*(4/3) = 192 | 192/48 = | 4*48 = 192 |
| | bits | 4 OFDM | |
| | | symbols | |
| QPSK 1/2 | (18*8)*(2/1) = 288 | 288/96 = | 3*48 = 144 |
| | bits | 3 OFDM | |
| | | symbols | |
| QPSK 3/4 | (18*8)*(4/3) = 192 | 192/96 = | 2*48 = 96 |
| | bits | 2 OFDM | |
| | | symbols | |
| 16-QAM 1/2 | (18*8)*(2/1) = 288 | 288/192 = | 2*48 = 96 |
| | bits | 2 OFDM | |
| | | symbols | |
| 16-QAM 3/4 | (18*8)*(4/3) = 216 | 261/288 = | 1*48 = 48 |
| | bits | 1 OFDM | |
| | | symbol | |
| 64-QAM 2/3 | (18*8)*(3/2) = 216 | 216/288 = | 1*48 = 48 |
| | bits | 1 OFDM | |
| | | symbol | |
| 64-QAM 3/4 | (18*8)*(4/3) = 192 | 192/288 = | 1*48 = 48 |
| | bits | 1 OFDM | |
| | | symbol | |

The transmission mode setting module 122 includes a memory for storing information on a success parameter, a failure parameter, and a retransmission parameter in accordance with information on whether the receiving side receives a response message, determines channel states by modifying the success parameter, the failure parameter, and the retransmission parameter depending on receiving of a response signal from the soft-decision demodulation module 124, and controls the modulator 110 based on determined information.

The transmitting/receiving module 130 transmits the data transmitted from the modulator 110 to a receiving end, and transmits the data received at the receiving end to the soft-decision demodulation module 124.

The transmitting apparatus of the wireless communication system determines a transmission mode on the basis of the number of soft-decision data obtained by demodulating the response data, and thus data transmission can be performed through an efficient channel adaptation.

A method for data transmission in accordance with a transmission mode by using a transmitting apparatus of the wireless communication system will now be described.

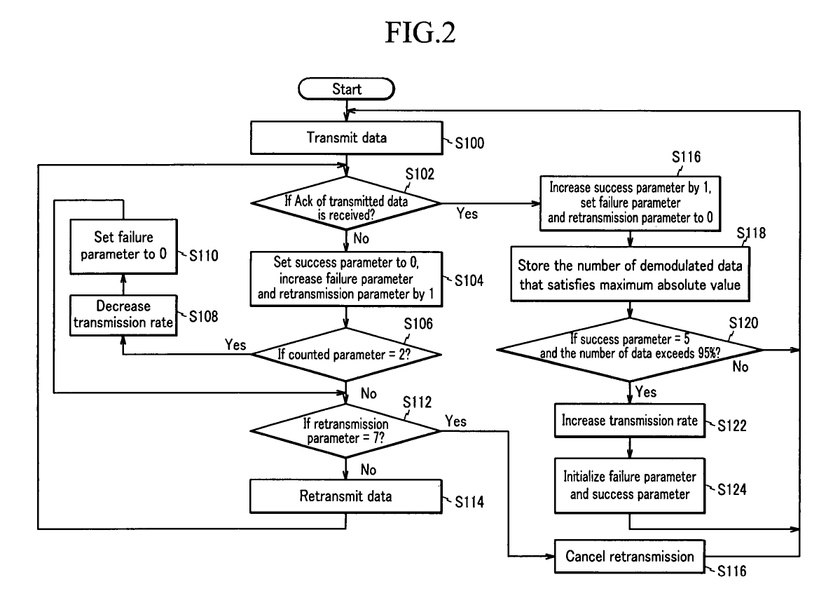

FIG. 2 is a flowchart showing a data transmission method of a transmitting apparatus of the wireless communication system according to an exemplary embodiment of the present invention.

As shown in FIG. 2, the transmitting apparatus modulates data bits and transmits modulated data to a receiving end. The transmitting apparatus changes a transmission mode based on a response of the receiving end and transmits the next data.

The transmitting apparatus 100 modulates data bits transmitted from a previous end of the transmitting apparatus 100 in accordance with a predetermined modulation scheme and transmits modulated data bits to the receiving end through the transmitting/receiving module 130, in step S100.

When the transmitting apparatus 100 transmits initial data to the receiving end, the transmission mode is set to be a peak data rate mode. After transmission of the initial data with the peak data rate, data is transmitted with a changed transmission mode.

The transmitting apparatus 100 checks whether the receiving end has transmitted a response message (ACK) in response to the data transmitted thereto in step S102, and increases the success parameter by 1 when the response message has been successfully received and sets the failure and retransmission parameters respectively to 0 in step S116. Then, the transmitting apparatus 100 demodulates the response message and stores the number of soft-decision data that satisfy the predetermined maximum absolute value according to the demodulation, in step S118. At this time, the transmitting apparatus 100 determines whether the response message (ACK) has been received through an ACK time-out of the transmitting apparatus 100.

The transmitting apparatus 100 determines whether the stored success parameter corresponds to 5 and the number of soft-decision data satisfies a condition of more than 95% in step S120. When the success parameter is 5 and the number of soft-decision exceeds the 95% condition in step S120, the transmitting apparatus 100 increases the transmission rate by changing a transmission mode (i.e., a modulation scheme and a convolutional code parameter) in step S122, and initializes a count parameter, the retransmission parameter, and the success parameter, and then transmits the next data based on the changed transmission mode in step S124.

In this case, the 95% condition is based on the comparison of the number of soft-decision data and the number of data allocated to the packet stored in the transmitting apparatus 100 as shown in Table 1. That is, when the number of soft-decision data exceeds 95% of the number of data allocated to the packet, the transmitting apparatus 100 determines that the channel is in a good state, and when the number of soft-decision data does not exceed 95% of the number of data allocated to the packet, the transmitting apparatus 100 determines that the channel is in a bad state.

In step S120, when a success parameter stored in the transmitting apparatus 100 corresponds to 5 and the number of soft-decision data does not exceed 95% of the number of data allocated to the packet, the next data transmission is performed in accordance with a transmission mode of a previous data transmission, in step S100. That is, when the success parameter corresponds to 5 and the number of soft-decision data does not exceed 95% of the number of data allocated to the packet, a current transmission mode is maintained.

When the transmitting apparatus 100 does not receive response data (i.e. ACK) for data that have been transmitted from the transmitting apparatus 100 in step S102, the stored success parameter is set to “0”, and a failure parameter and a retransmission parameter are incremented by “1” in step S104.

The transmitting apparatus 100 determines whether a count parameter corresponds to “2” in step S106, and decreases the transmission rate by changing a transmission mode when the count parameter corresponds to “2”, and resets the count parameter to “0” in step S110. Then, step S102 and its subsequent steps are performed.

When the count parameter stored in the transmitting apparatus 100 does not correspond to “2” in step S106, the transmitting apparatus 100 determines whether the retransmission parameter corresponds to “7” in step S112, and retransmits the last transmitted data when the retransmission parameter does not correspond to “7” in step S114.

When the retransmission parameter stored in the transmitting apparatus 100 does not correspond to “7” in step S112, the retransmission of the last transmitted data is canceled in step S116 and the transmitting apparatus 100 transmits the next data.

Such a transmitting apparatus according to the above-described exemplary embodiment of the present invention has advantages of providing an effective transmission mode for a channel condition with reference to the number of soft-decision data and determining a transmission mode by using only response data.

The above-described exemplary embodiment of the present invention may be realized by an apparatus and a method, but it may also be realized by a program that realizes functions corresponding to configurations of the exemplary embodiment or a recording medium that records the program. Such a realization can be easily performed by a person skilled in the art.

With the above-described configuration, the transmitting apparatus can provide an effective transmission mode for a channel condition with reference to the number of soft-decision data.

In addition, the transmitting apparatus can determine a transmission mode by using only response data.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmitting apparatus of a wireless communication system, comprising:
a transmitting/receiving module for exchanging data with a receiving end;
a modulator for modulating a received data bit according to a transmission mode, and transmitting the modulated data to the transmitting/receiving module; and
a demodulator including a first parameter for counting the number of successful receipts, a second parameter for counting the number of failed receipts, a third parameter for counting the number of data retransmissions, changing the first, second, and third parameters according to receipt of response data corresponding to the modulated data, demodulating the response data and extracting the number of demodulated data that satisfies a specific value, and determining a transmission mode based on the first parameter, the second parameter, the third parameter, and the number of demodulated data satisfying the specific value.

2. The transmitting apparatus of claim 1, wherein the demodulator increases the first parameter when receiving the response data from the transmitting/receiving module, extracts the number of data that satisfies the specific value by demodulating the received response data, and increases a transmission rate by changing the transmission mode based on the extracted number of data and the increased first parameter.

3. The transmitting apparatus of claim 2, wherein the demodulator increases the second and third parameters according to a failure of receiving of the response data, decreases the transmission rate by changing the transmission mode when the increased second parameter satisfies a first set value, and retransmits data when the increased third parameter satisfies a second set value.

4. The transmitting apparatus of claim 1, wherein the demodulator comprises:
a soft-decision modulation module for modulating the response data, extracting the number of soft-decision data having a specific value, and storing the extracted number of soft-decision data; and
a transmission mode decision module for managing the first, second, and third parameters, and determining a transmission mode based on the number of data transmitted from the soft-decision modulation module and the first, second, and third parameters.

5. The transmitting apparatus of claim 4, wherein the transmission mode decision module comprises packet information in which the number of packet bits according to a modulation method is stored, and it increases a transmission rate by changing the transmission mode based on information on comparison between the number of data and the packet information and the first parameter, and determines whether to perform retransmission or decreases the transmission rate by changing the transmission mode based on the second and third parameters.

6. The transmitting apparatus of claim 1, wherein the modulator comprises a convolutional encoding module, and it modulates data based on a modulation method determined in accordance with the transmission mode and a convolutional code parameter.

7. A transmission method of a wireless communication system that transmits specific data to a receiving end, the transmission method comprising:
a) monitoring receiving of response data for data that has been transmitted to the receiving end;
b) setting a first parameter for counting successful receipts according to the receiving of the response data;
c) demodulating the response data, and extracting the number of data that satisfies a first set value according to the demodulation;
d) determining whether the first parameter satisfies a second set value and determining whether the number of data satisfies a predetermined ratio of a referential amount of packets; and
e) changing a transmission mode when the second set value and the predetermined ratio are satisfied according to a result of the determination.

8. The transmission method of claim 7, wherein the transmission method further comprises not changing the transmission mode when the set value and the predetermined ratio are not satisfied.

9. The transmission method of claim 8, wherein b) comprises:
increasing the first parameter by a specific number according to the receiving of the response data; and
initializing a second parameter and a third parameter according to the receiving of the response data, the second parameter counting receiving failures and the third parameter counting retransmissions.

10. The transmission method of claim 7, wherein when the receiving of the response data has failed after a), the transmission method further comprises:
i) setting a second parameter for counting receiving failures and a third parameter for counting data retransmissions;
ii) performing a first determination on whether the second parameter satisfies a third set value;
iii) changing the transmission mode when the second parameter satisfies the third set value according to the first determination; and
iv) initializing the second parameter.

11. The transmission method of claim 10, wherein iii) comprises:
performing a second determination on whether the third parameter satisfies a fourth set value when the second parameter does not satisfy the third set value according to the first determination; and
retransmitting the transmitted data when the third parameter satisfies the fourth set value according to the second determination.

12. The transmission method of claim 11, further comprising canceling the retransmission of the transmitted data when the third parameter does not satisfy the fourth set value according to the second determination.
